(19) United States
(12) Patent Application Publication
(10) Pub. No.: US 2025/0308433 A1
(43) Pub. Date: Oct. 2, 2025

(54) VISIBLE-SPECTRUM EYE TRACKING FOR DYNAMIC COLOR CALIBRATION OF BINOCULAR MICROLED WAVEGUIDE DISPLAYS

(71) Applicant: GOOGLE LLC, Mountain View, CA (US)

(72) Inventors: Ardavan Oskooi, San Francisco, CA (US); Jouya Jadidian, Los Gatos, CA (US); Reza Tafteh, Santa Clara, CA (US)

(21) Appl. No.: 18/624,669

(22) Filed: Apr. 2, 2024

(51) Int. Cl. G09G 3/32; G02B 27/00; G02B 27/01

(52) U.S. Cl. CPC G09G 3/32; G02B 27/0093; G02B 27/0172; G02B 2027/0112; G02B 2027/0178; G09G 2320/0666; G09G 2320/0693

(57) ABSTRACT

A color calibration system is included on a head-mounted display (HMD) to detect one or more pupil locations within an eyebox. A controller is configured to send one or more signals to a light engine to include an embedded marker within an image rendered on a waveguide that is projected toward at least one eye of the user. The one or more sensors are configured to detect the embedded marker as reflected off the at least one eye. Additionally, the color calibration system calibrates color at the one or more pupil locations to provide color uniformity of the display where the pupil is looking at any given time.

### BACKGROUND

A head-mounted display (HMD) is a type of display device worn on a head of a user. HMDs provide an immersive display of digital content for virtual reality (VR) applications and/or augmented reality (AR) applications. In order to provide the digital content for display, HMDs employ a waveguide that directs light from a light engine toward an eye of the user. However, each waveguide developed by a manufacturer will have relatively different physical properties and correspondingly different performance characteristics. These types of differences may be the result of differences in how the waveguide is constructed and/or materials used. As a result, the waveguide often produces a large variation in efficiency (e.g., nits per nits) in displaying an image over a field of view (FOV) at different pupil locations in an eyebox. In other words, the waveguide has imperfections or is nonuniform in displaying the image at different portions of the eyebox. For example, red-green-blue (RGB) color channels presented to the user within the eyebox will have slight variations in luminance (i.e., brightness) and chrominance (i.e., color) that degrades the quality of the image and the overall viewing experience for the user. Typically, the color nonuniformity is compensated in post-fabrication using color balancing by dimming the brightest subpixels of a micro light-emitting diode (microLED) panel.

However, color balancing has two limitations. First, color balancing is a permanent, one-time procedure implemented in the firmware of a driver circuit for the microLED panel. Second, color balancing is based on compensating for the mean per-color brightness level at a given angle of the FOV that is obtained by averaging over all pupil locations in the eyebox. Despite these corrections, color balancing does not improve color uniformity at many pupil locations and lowers wall-plug efficiency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a display system housing a projector system configured to project images toward the eye of a user, in accordance with some embodiments.

FIG. 2 is a block diagram illustrating a color calibration system configured to detect a pupil location and calibrate color based on the pupil location, in accordance with some embodiments.

FIG. 3 is a diagram illustrating a plurality of eye tracking sensors configured to detect a pupil location within an eyebox, in accordance with some embodiments.

FIG. 4 is a diagram of an example of a plurality of sensors detecting embedded markers at various pupil locations, in accordance with some embodiments.

FIG. 5 is a flow diagram illustrating a method for detecting a pupil location and calibrating color based on the pupil location, in accordance with some embodiments.

### DETAILED DESCRIPTION

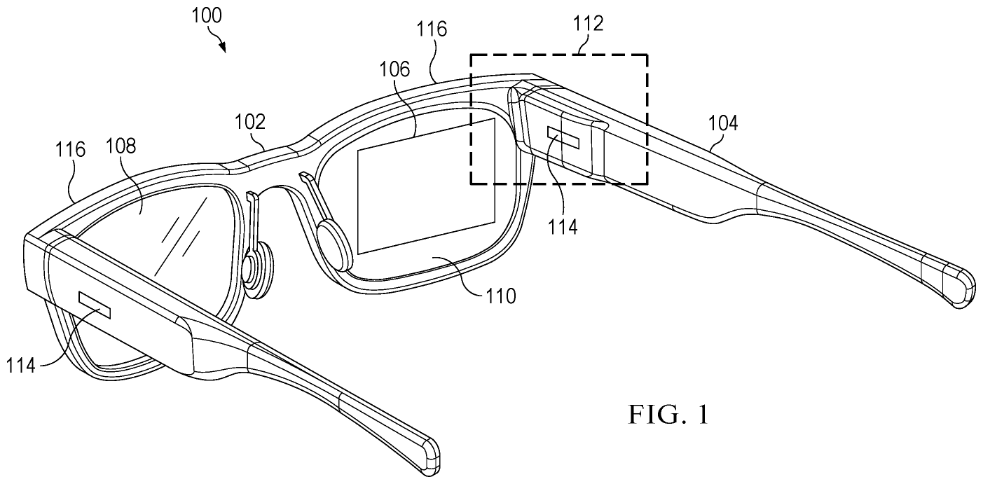

FIGS. 1-5 illustrate systems and techniques for detecting one or more pupil locations within an eyebox for a display system, such as a head-mounted display (HMD), and calibrating color at the one or more pupil locations to provide color uniformity. The one or more pupil locations are one or more positions of the display where the pupil is looking at any given time. A controller disposed within the HMD employs an eye-tracking process wherein one or more low-power sensors are configured to detect the one or more pupil locations within the eyebox. That is, the one or more sensors detect one or more positions where each pupil of a user is focused (e.g., where the pupil is looking). Moreover, the controller independently determines the one or more pupil locations for each pupil of the user. For example, the controller determines a first pupil location for a first pupil (e.g., a left eye) and a second pupil location for a second pupil (e.g., a right eye). In this example, the first pupil location may be different from the second pupil location, or they may be the same depending on the one or more pupil locations detected by the one or more sensors.

Under conventional methods, eye tracking has two main techniques. The first conventional technique is glint based which employs multiple sources of light (e.g., infrared) and one or more camera apertures. Moreover, the glint based approach uses deterministic algorithms and demands a high amount of raw processing (e.g., CPU) power to support a high rate of illumination and image sensing captures. The glint based approach is not suitable for an always-on implementation of eye tracking and has limited field of view (FOV). The limited FOV of the glint based approaches is due to occlusions and placement of the one or more camera apertures. The second technique is computer vision (CV) based image processing with flood illumination with direct or indirect view of the eye. The CV based approach uses machine learning with a strong synthetic pipeline or diverse real captures. However, calibration or training of the CV based approach is difficult during in field use and accuracy of eye tracking is worse than glint based. The CV based approach facilitates eye imaging applications, such as iris recognition. Also, in some cases, the CV approach includes infrared (IR) illumination that enables vision to detect objects in relatively poor lighting conditions, such as a reflective surface that produces high or low levels of illumination. However, the CV approach does not support always-on implementation because of the IR illumination and a high power draw due to the CV and machine learning processes. Like the glint based approach, the CV approach has limited FOV.

In contrast to the above approaches, by applying the techniques described herein, the controller employs the one or more sensors to detect data in a visible spectrum and using a sparse sampling approach. The one or more sensors are always on by being available to detect at any given time. In other words, no additional power is required to turn on the one or more sensors. Moreover, by distributing the one or more sensors around a frame of the HMD, the FOV coverage is improved. To illustrate, the one or more sensors are disposed around the frame surrounding each lens of the HMD. The controller is configured to send one or more signals to a light engine to include an embedded marker, such as a symbol, a character, and the like. As such, the light engine includes the embedded marker within an image rendered on a waveguide that is projected toward at least one eye of the user. However, the embedded marker is generated in the visible spectrum using sparse sampling (i.e., periodic sampling), such that the embedded marker is unnoticeable by the user. That is, since the embedded marker is rendered in a relatively brief and sparse manner, the embedded marker is not noticeable to the user. The one or more sensors are configured to detect the embedded marker as reflected off a cornea and/or a sclera. Accordingly, the one or more sensors transmit data including the one or more positions of each pupil to the controller. In response to receiving the data, the controller determines the one or more pupil locations within the eyebox.

In addition to determining the one or more pupil locations, the controller retrieves an efficiency map of the waveguide to determine physical properties and operating characteristics of the waveguide. Stated differently, the efficiency map includes data indicating how efficient each portion of the waveguide operates while displaying an image. The efficiency map indicates efficiency of the FOV at the one or more pupil location in the eyebox based on simulation or testing performed on the waveguide prior to assembly of the HMD. For example, the efficiency map includes nits per nits efficiency and color information at different portions of the waveguide. Accordingly, based on the efficiency map, the controller determines differences of luminance and/or chrominance for each subpixel at different portions of the eyebox. To provide a relatively good viewing experience, the controller calibrates a driver circuit to adjust current densities to adjust the subpixel brightness and/or colors of the light engine in response to the one or more pupil locations and the efficiency map. For example, the driver circuit may increase the current density to a first pupil location and/or decrease the current density at a second pupil location to increase and/or decrease brightness in response to calibration by the controller. The controller improves the viewing experience by improving color uniformity at the one or more pupil locations based on adjustments to the current densities. Using the techniques described herein, power consumption is reduced due to the low-power sensors and by applying the sparse sampling approach. Furthermore, using the techniques described herein, wall-plug efficiency is improved as well as the color balancing and color uniformity of the FOV is improved at specific pupil locations.

FIG. 1 illustrates a display system 100 having a frame 102 that includes a first arm 104, which houses a projection system configured to project display light representative of images toward an eye of a user, such that the user perceives the projected images as being displayed in a field of view (FOV) area 106 of a display at a first lens 108 and/or a second lens 110. In the depicted embodiment, the display system 100 is an HMD that includes the frame 102 configured to be worn on the head of a user and has a general shape and appearance of a pair of eyeglasses. The frame 102 contains or otherwise includes various components to facilitate the projection of such images toward the eye of the user, such as a plurality of light engines 114, a plurality of projectors, a plurality of optical scanners, and a plurality of waveguides 116. In some embodiments, the frame 102 further includes various sensors, such as one or more front-facing cameras, rear-facing cameras, world cameras, eye-tracking cameras, other light sensors, motion sensors, accelerometers, inertial mass units, and the like. The frame 102 further can include one or more radio frequency (RF) interfaces or other wireless interfaces, such as a Bluetooth® interface, a Wi-Fi interface, and the like. Further, in some embodiments, the frame 102 further includes one or more batteries or other portable power sources for supplying power to the electrical components of the display system 100. In some embodiments, some or all of these components of the display system 100 are fully or partially contained within an inner volume of the frame 102, such as within the arm 104 in a region 112 of the frame 102. It should be noted that while an example form factor is depicted, it will be appreciated that in other embodiments the display system 100 may have a different shape and appearance from the eyeglasses frame depicted in FIG. 1.

The first lens 108 and/or the second lens 110 are used by the display system 100 to provide an augmented reality (AR) display in which rendered digital content can be superimposed over or otherwise provided in conjunction with a real-world view as perceived by the user through the first lens 108 and/or the second lens 110. For example, display light used to form a perceptible image or series of images may be projected by at least one light engine 114 of the display system 100 onto the eye of the user via a series of optical elements, such as the plurality of waveguides 116 disposed at least partially within or otherwise connected to the first lens 108 and/or the second lens 110, one or more scan mirrors, and one or more optical relays. Thus, in some embodiments, the first lens 108 and/or the second lens 110 include at least a portion of a waveguide 116 that routes display light received by an incoupler of each waveguide 116 to an outcoupler of each waveguide 116, which outputs the display light toward an eye of a user of the display system 100. The display light is modulated and scanned onto the eye of the user such that the user perceives the display light as an image. In addition, the first lens 108 and/or the second lens 110 are sufficiently transparent to allow a user to see through the lens elements to provide a FOV of the user's real-world environment such that the image appears superimposed over at least a portion of the real-world environment.

In some embodiments, each light engine 114 is a digital light processing-based projector, a microLED microdisplay, scanning laser projector, or any combination of a modulative light source. For example, according to some embodiments, each light engine 114 includes a laser or one or more LEDs and a dynamic reflector mechanism such as one or more dynamic scanners or digital light processors. In some embodiments, each light engine 114 includes multiple laser diodes (e.g., a red laser diode, a green laser diode, and/or a blue laser diode) and at least one scan mirror (e.g., two one-dimensional scan mirrors, which may be MEMS-based or piezo-based). Each light engine 114 is communicatively coupled to the controller and a non-transitory processor-readable storage medium or a memory that stores processor-executable instructions and other data that, when executed by the controller, cause the controller to control the operation of each light engine 114. In some embodiments, the controller controls a scan area size and scan area location for each light engine 114 and is communicatively coupled to a processor (not shown) that generates content to be displayed at the display system 100. Each light engine 114 scans light over a variable area, designated the FOV area 106, of the display system 100. The scan area size corresponds to the size of the FOV area 106 and the scan area location corresponds to a region of the first lens 108 and/or the second lens 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

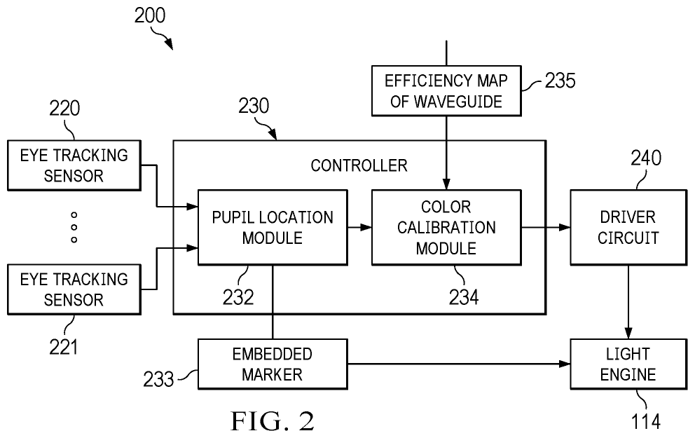

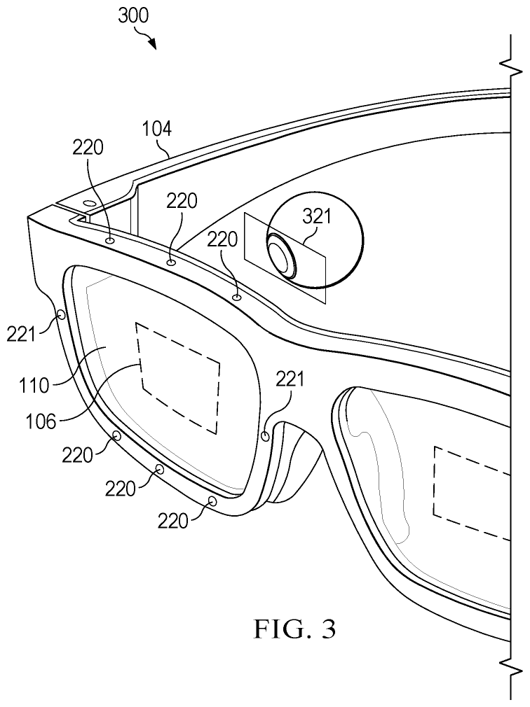

FIG. 2 illustrates a block diagram of a color calibration system 200 configured to detect a pupil location and calibrate color emitted from the light engine 114 based on the pupil location, in accordance with some embodiments. The color calibration system 200 include one or more components of the display system 100. Specifically, in various embodiments, the color calibration system includes one or more eye tracking sensors, such as, for example, eye tracking sensor 220 and an eye tracking sensor 221, a controller 230, and a driver circuit 240. In the depicted example and for ease of description, only the eye tracking sensor 220 and the eye tracking sensor 221 are shown. However, in different embodiments, more eye tracking sensors are included, such as depicted in FIG. 3, and as will be described below. Furthermore, in different embodiments, the color calibration system 200 includes more components than those depicted in FIG. 2.

In some embodiments, each of the eye tracking sensors 220, 221 includes a photodetector such as a photodiode. Alternatively, in different embodiments, each of the eye tracking sensors 220, 221 includes a low-resolution camera. Also, the eye tracking sensors 220, 221 are low-power sensors to minimize power draw. The eye tracking sensors 220, 221 are disposed on at least a portion of the frame 102. For example, the eye tracking sensor 220 is disposed on at least a portion of the frame 102 proximal to the first lens 108 and distal from the second lens 110. In contrast, for example, the eye tracking sensor 221 is disposed on at least a portion of the frame 102 proximal to the second lens 110 and distal from the first lens 108. The eye tracking sensors 220, 221 are configured to measure light intensity using 8 to 12 bits over a range of levels from 0 to 255 or 0 to 4095, respectively. Moreover, the eye tracking sensors 220, 221 detect one or more positions of at least one pupil of at least one eye of the user.

To determine the one or more positions of the at least one pupil, the controller 230 receives data indicating the one or more positions of the at least one pupil on the display from the eye tracking sensors 220, 221. The one or more positions of the at least one pupil on the display are also referred to as one or more pupil locations. Additionally, the one or more pupil locations identify where the at least one pupil is determined to be focused on within the eyebox. That is, the eyebox is an area relative to the frame of the display system 100 where at least one eye (or both if each lens includes the waveguide 116) receives an entire view of the image projected from the light engine 114. Thus, the controller 230 determines the one or more pupil locations in response to receiving the data from the eye tracking sensors 220, 221.

To facilitate detection of the one or more pupil locations, the controller 230 employs a pupil location module 232. In some embodiments, the pupil location module 232 is a software application. In different embodiments, the pupil location module 232 is a dedicated processing device, such as an application-specific integrated circuit (ASIC), a field-programmable gate array (FPGA), and the like. The pupil location module 232 generates an embedded marker 233, such as a symbol, a character, and the like. Subsequently, the pupil location module 232 sends the embedded marker 233 to the light engine 114 and employs a sparse sampling approach by periodically including the embedded marker 233. In response to receiving the embedded marker 233, the light engine 114 includes the embedded marker 233 within an image projected from the light engine 114 and rendered on one or more waveguides 116. The embedded marker 233 is projected within the image on a visible spectrum that corresponds to electromagnetic wavelengths of 400 nanometers (nm) to 700 nm and is displayed as monochrome or RGB. In other words, the embedded marker 233 is generated on an electromagnetic spectrum visible to the user. However, the embedded marker 233 is included in the image in a sparse manner such that a shape, a size, and/or other features of the embedded marker 233 are unnoticeable to the user. To illustrate via an example, the image rendered on the one or more waveguides 116 by the light engine 114 includes text and a picture. The pupil location module 232 sends the embedded marker 233 using sparse sampling to the light engine 114 to be included within the text and/or the picture at one or more predefined pupil locations within the eyebox at predetermined intervals. In some embodiments, the pupil location module 232 randomly determines the one or more predefined pupil locations. Alternatively, and/or in addition thereto, in different embodiments, the pupil location module 232 has preset (i.e., fixed) locations such that the light engine 114 includes the embedded marker 233 at the one or more predefined pupil locations that have been preset, such as, for example, during setup or at manufacture. The embedded marker 233 is included in the image such that the embedded marker 233 appears indistinguishable from other features of the entire image. In other words, during operation, the embedded marker 233 is integrated into the image and appears similar to other portions of the image (e.g., edges, pixels, text, etc.).

Based on the embedded marker 233, the eye tracking sensors 220, 221 detect the one or more pupil locations with respect to the eyebox. More specifically, the eye tracking sensors 220, 221 detect the presence of the embedded marker 233 within the eyebox at the one or more pupil locations in response to reflection of the embedded marker 233 from at least one of a cornea and a sclera of at least one eye of the user. To illustrate, as above, the one or more waveguides 116 render the image projected from the light engine 114. The light engine 114 includes the embedded marker 233 at the one or more pupil locations based on instructions from the pupil location module 232. As such, during operation by the user, the eye tracking sensors 220, 221 detect the one or more positions of at least one pupil of the user in response to reflection of the embedded marker 233 from the cornea and/or the sclera toward the eye tracking sensors 220, 221. Thus, the reflection of the embedded marker 233 toward the eye tracking sensors 220, 221 corresponds to the one or more positions of the at least one pupil, and accordingly, the reflection of the embedded marker 233 indicates where the user is looking. The pupil location module 232 receives the data from the eye tracking sensors 220, 221 to determine the one or more pupil locations based on the data detected by the eye tracking sensors 220, 221.

In some embodiments, the pupil location module 232 includes a lookup table to determine the one or more pupil locations. For example, based on the embedded marker 233 detected by the eye tracking sensors 220, 221, the pupil location module 232 determines the one or more pupil locations that correspond to entries in the lookup table, such as the data (e.g., the embedded marker 233) detected by the eye tracking sensors 220, 221 that correspond to specific pupil locations identified in the lookup table. In different embodiments, the pupil location module 232 includes a ray tracer to determine the one or more pupil locations. For example, based on the embedded marker 233 detected by the eye tracking sensors 220, 221, the pupil location module 232 determines the one or more pupil locations through a reverse engineering process by using ray tracing to locate where the embedded marker 233 is detected (i.e., where a reading of the embedded marker was generated) within the eyebox. In different embodiments, the pupil location module 232 includes a machine learning (ML) algorithm to determine the one or more pupil locations. For example, based on the embedded marker 233 detected by the eye tracking sensors 220, 221, the pupil location module 232 determines the one or more pupil locations based on the ML algorithm that uses artificial intelligence (AI) to learn pupil locations with known samples of the one or more waveguides 116 prior to development of the display system 100.

The above-described examples of operation of the pupil location module 232 include situations where outcoupled light from the one or more waveguides 116 reaches the pupil. In situations where the display system 100 is not displaying any digital content (e.g., the display system 100 is off), then eye tracking is ordinarily not required. However, where eye tracking is required in low light situations, the pupil location module 232 sends commands to the light engine 114 to emit near infrared (IR) dots similar to the embedded marker 233. In such cases, the eye tracking sensors 220, 221 detect the near IR dots using the same process described above.

After determining the one or more pupil locations, the pupil location module 232 sends the one or more pupil locations to a color calibration module 234. The controller 230 employs the color calibration module 234 to improve color uniformity within the eyebox and improve the viewing experience. Specifically, the color calibration module 234 retrieves one or more efficiency maps 235 of the one or more waveguides 116 for the FOV from the one or more pupil locations from the storage medium or memory discussed above with reference to FIG. 1. Each efficiency map 235 includes information on how efficient the one or more waveguides 116 for the FOV at the one or more pupil locations detected by the pupil location module 232 operate while displaying an image. For example, each efficiency map 235 includes nits per nits efficiency and color information at different portions of the waveguide 116. Stated differently, each efficiency map 235 indicates physical properties and/or operating characteristics of the one or more waveguides 116 for the FOV at the one or more pupil locations. As such, based on the efficiency map 235, the color calibration module 234 determines current densities for each RGB subpixel, or all RGB subpixels of the same color, to change the microLED panel of the light engine 114 and adjust color balance at different portions of the one or more waveguides 116. In some embodiments, the color calibration module 234 includes a lookup table to handle color calibration of subpixels within the light engine 114. In particular, the lookup table includes entries that identify a level of adjustment for illumination and/or color based on the efficiency map 235 and the one or more pupil locations corresponding to portions of the display. In different embodiments, the color calibration module 234 includes a non-linear optimization of the FOV at the one or more pupil locations to identify settings for the driver circuit 240. Specifically, by employing non-linear optimization, the color calibration module 234 calculates the level of adjustment for illumination and/or color based on properties of the waveguide 116 identified in the efficiency map 235 and the one or more pupil locations corresponding to portions of the display. Thus, the color calibration module 234 determines settings by non-linear optimization using multiple variables (e.g., the efficiency map 235 and the one or more pupil locations). For example, the color calibration module 234 optimizes illumination and/or color for the FOV at the one or more pupil locations in response to the one or more pupil locations detected by the pupil location module 232 and based on a range of illumination output at the one or more pupil locations with respect to the efficiency map 235.

Herein, for ease of description an example implementation of the look up table is described. For example, the look up table identifies settings (e.g., color, brightness) for the driver circuit 240 that creates a specific result of the image at the one or more pupil locations based on the one or more pupil locations and the efficiency map 235. In other words, the look up table includes information necessary to adjust the driver current of the subpixels within the light engine 114 at particular pupil locations that will provide color and brightness that is intended for the image, rather than the color and brightness the one or more waveguides 116 produce without adjustment from the color calibration module 234. For example, the color calibration module 234 measures a light intensity (e.g., brightness) at a subpixel and a second light intensity at a second subpixel. In order to achieve color uniformity, the color calibration circuit 234 adjusts the driver current to change the light intensity of the second subpixel to match the first subpixel. In absence of adjustment to the driver circuit 240, the FOV at the one or more pupil locations is displayed with color nonuniformity and a relatively poor viewing experience. Thus, in response to receiving the one or more pupil locations from the pupil location module 232 and based on the efficiency map 235, the color calibration module 234 sends commands to the driver circuit 240 to adjust the driver current to adjust brightness and/or color of the subpixels of the light engine 114 corresponding to the one or more pupil locations to provide color uniformity and improve the viewing experience. The color uniformity is improved by matching the color point for white, red, green, and blue to a known reference value (e.g., CIE D65, or other standard illuminant). In some embodiments, the color calibration module 234 employs a white point metric (e.g., CIE D65) using relative perceived brightness of the RGB channels. The color calibration module 235 uses the efficiency map 235 to determine average efficiency of RGB over the FOV. In some embodiments, a weighted average of the FOV is based on the content (e.g., the image) being rendered on the display. Once the average efficiency for the FGB in the FOV is determined, the color calibration module 234 sends commands to the driver circuit to adjust current density for the RGB subpixels of the microLED panel to obtain a white point closest to, CIE D65.

FIG. 3 illustrates a diagram of a section 300 of the display system 100 having a plurality of eye tracking sensors disposed around the second lens 110 and configured to detect a pupil location within an eyebox 321, in accordance with some embodiments. In the depicted example, the second lens 110 is surrounded by eight of the eye tracking sensors 220, 221. As discussed above, it will be appreciated that in different embodiments, there may be more or less than the eight eye tracking sensors 220, 221.

The eye tracking sensors 220, 221 are positioned and configured at particular angles with respect to the eyebox 321 to maximize coverage of the eyebox 321. In particular, one or more of the eye tracking sensors 220, 221 are positioned to cover the same area as a form of redundancy and to improve accuracy during detection of the embedded marker 233. Additionally, each of the eye tracking sensors 220, 221 are spaced and separated to ensure coverage of multiple portions of the eyebox 321. For example, a first of the eye tracking sensors 220 covers a first region of the eyebox 321 and a second of the eye tracking sensors 220 covers a second region of the eyebox 321 different from the first region of the eyebox 321. In some embodiments, the second region of the eyebox 321 at least partially overlaps with the first region. However, in different embodiments, the second region of the eyebox 321 does not overlap with the first region.

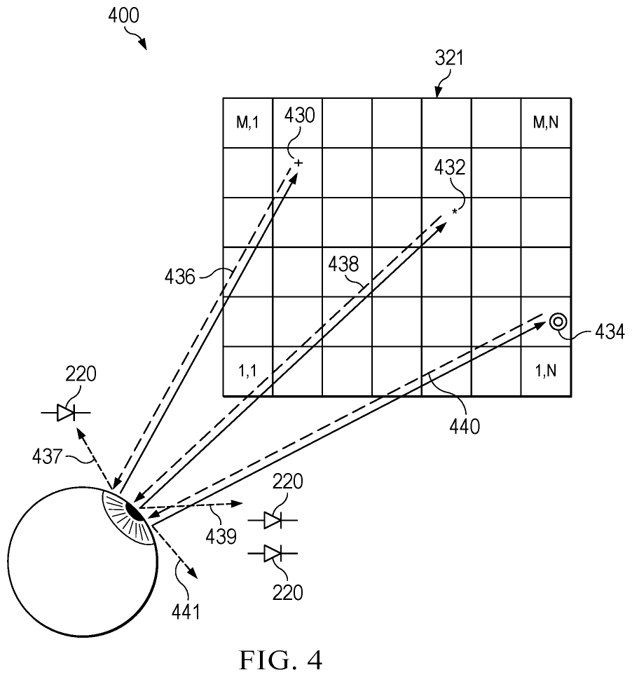

FIG. 4 illustrates an example 400 of a plurality of eye tracking sensors 220 detecting embedded markers at various pupil locations, in accordance with some embodiments. In the depicted example, the eyebox 321 is represented by a two-dimensional (2D) plane or grid with size from 1,1 to M,N. In other words, a Y-axis of the eyebox 321 is defined by 1 to M and an X-axis of the eyebox is defined by 1 to N. Each of the eye tracking sensors 220 corresponds to at least one of the eye tracking sensors 220, 221 described above. Furthermore, each of the eye tracking sensors 220 is disposed around the first lens 108 or the second lens 110 as described above.

In the depicted example, the pupil is focused at three different locations at three different times. In a first scenario, an embedded marker 430, represented as a “+” symbol, is included in the image at a first region in the eyebox 321. The embedded marker 430 is observed by the pupil and a first light beam 436 corresponding to the embedded marker 430 is projected to the pupil. A first reflected light beam 437 reflects off the cornea of the pupil and corresponds to the first light beam 436 and the embedded marker 430. A first of the eye tracking sensors 220 receives the first reflected light beam 437 and sends the data to the pupil location module 232 for further processing.

In a second scenario, an embedded marker 432, represented as a “*” symbol, is included in the image at a second region in the eyebox 321. The embedded marker 432 is observed by the pupil and a second light beam 438 corresponding to the embedded marker 432 is projected to the pupil. A second reflected light beam 439 reflects off the cornea of the pupil and corresponds to the second light beam 439 and the embedded marker 432. A second of the eye tracking sensors 220 receives the second reflected light beam 439 and sends the data to the pupil location module 232 for further processing.

In a third scenario, an embedded marker 434, represented as a symbol, is included in the image at a third region in the eyebox 321. The embedded marker 434 is observed by the pupil and a third light beam 440 corresponding to the embedded marker 434 is projected to the pupil. A third reflected light beam 441 reflects off the cornea of the pupil and corresponds to the third light beam 440 and the embedded marker 434. A third of the eye tracking sensors 220 receives the third reflected light beam 441 and sends the data to the pupil location module 232 for further processing.

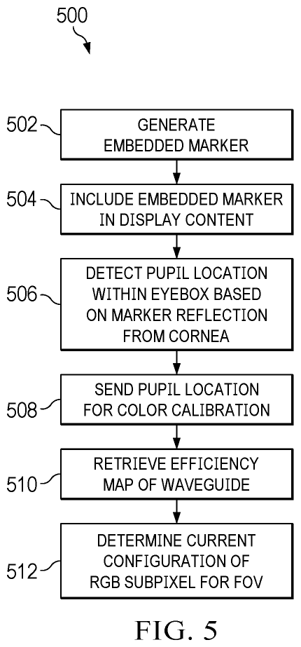

FIG. 5 illustrates a flow diagram for a method 500 to detect a pupil location and calibrate color based on the pupil location, in accordance with some embodiments. The method 500 is described with respect to an example implementation of the color calibration system 200 of FIG. 2. At block 502, the pupil location module 232 generates the embedded marker 233. At block 504, the pupil location module 232 sends the embedded marker 233 to the light engine 114. In response to receiving the embedded marker 233, the light engine 114 includes the embedded marker 233 within the image projected from the light engine 114 and rendered on the on one or more waveguides 116. The pupil location module 232 sends the embedded marker 233 to the light engine 114 to be included within the text and/or the picture at the one or more pupil locations within the eyebox.

At block 506, the eye tracking sensors 220, 221 detect the one or more pupil locations with respect to the eyebox. More specifically, the eye tracking sensors 220, 221 detect the presence of the embedded marker 233 within the eyebox at the one or more pupil locations in response to reflection of the embedded marker 233 from at least one of a cornea and a sclera of at least one eye of the user. As such, during operation by the user, the eye tracking sensors 220, 221 detect the one or more positions of at least one pupil of the user in response to reflection of the embedded marker 233 from the cornea and/or the sclera toward the eye tracking sensors 220, 221. At block 508, the pupil location module 232 sends the one or more pupil locations to the color calibration module 234 to improve color uniformity within the eyebox. At block 510, the color calibration module 234 retrieves one or more efficiency maps 235 of the one or more waveguides 116 from the storage medium or memory. At block 512, the color calibration module 234 determines a configuration of the RGB subpixel for the FOV at different portions of the one or more waveguides 116. In response to receiving the one or more pupil locations from the pupil location module 232 and based on the efficiency map 235, the color calibration module 234 sends commands to the driver circuit 240 to adjust the driver current to adjust brightness and/or color of the RGB subpixels of the light engine 114 corresponding to the one or more pupil locations to provide color uniformity.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method, comprising:
detecting, by a plurality of eye tracking sensors and based on detecting an embedded marker within a spectrum visible to a user, at least one pupil location within an eyebox of a head-mounted display (HMD); and
calibrating, by a controller, at least one subpixel at the at least one pupil location based on the detected at least one pupil location and an efficiency map of a waveguide.

2. The method of claim 1, further comprising generating, by the HMD, the embedded marker.

3. The method of claim 2, wherein generating the embedded marker comprises:
generating the embedded marker within an image displayed by the HMD.

4. (canceled)

5. The method of claim 1, wherein detecting the embedded marker comprises:
detecting the embedded marker reflected from at least one of a cornea and a sclera of an eye.

6. The method of claim 1, wherein calibrating the at least one subpixel comprises:
determining a current-density setting of the at least one subpixel; and
adjusting the at least one subpixel to a configuration different from the current-density setting based on the at least one pupil location and the efficiency map.

7. The method of claim 6, further comprising:
maintaining a color balance of the at least one subpixel at each pupil location with respect to at least one second subpixel at a different pupil location within the eyebox.

8. The method of claim 7, wherein maintaining the color balance comprises:
determining an average efficiency for red-green-blue (RGB) over a field of view (FOV); and
adjusting a current-density for at least one RGB subpixel of a microLED panel to obtain a white point.

9. A head-mounted display (HMD), comprising:
a light engine configured to project a beam of light;
at least one waveguide configured to receive the beam of light and outcouple the beam of light;
a driver circuit configured to control at least one subpixel of a microLED panel;
a plurality of eye tracking sensors disposed on at least a portion of a frame and configured to detect, based on detecting an embedded marker within a spectrum visible to a user, at least one pupil location within the eyebox;
a controller configured to calibrate the driver circuit of the microLED panel to adjust the at least one subpixel at the at least one pupil location based on the at least one pupil location and an efficiency map of a waveguide in response to detecting the at least one pupil location.

10. The HMD of claim 9, wherein the controller is further configured to:
generate the embedded marker within the visible spectrum at the at least one pupil location.

11. The HMD of claim 9, wherein the plurality of eye tracking sensors are further configured to:
detect the embedded marker reflected from at least one of a cornea and a sclera of an eye.

12. The HMD of claim 10, wherein the controller is further configured to:
generate the embedded marker within an image displayed by the HMD.

13. The HMD of claim 9, wherein the controller is further configured to:
determine a current-density setting of the at least one subpixel; and
control the driver circuit to adjust the at least one subpixel to a configuration different from the current-density setting based on the at least one pupil location and the efficiency map.

14. The HMD of claim 13, wherein the controller is further configured to:
maintain a color balance of the at least one subpixel at each pupil location with respect to at least one second subpixel at a different pupil location within the eyebox.

15. The HMD of claim 14, wherein the controller is further configured to:
determine an average efficiency for red-green-blue (RGB) over a field of view (FOV); and
control the driver circuit to adjust a current-density for at least one RGB subpixel of the microLED panel to obtain a white point.

16. A method, comprising:
generating, by a controller, an embedded marker within content displayed on a head-mounted display (HMD), the embedded marker being generated by the controller in a spectrum visible to a user;
detecting, by a plurality of eye tracking sensors, the embedded marker corresponding to a pupil location of the user;
calibrating, by the controller, at least one subpixel based on the pupil location and an efficiency map of a waveguide in response to determining the at least one pupil location.

17. The method of claim 16, further comprising:
adjusting, by the controller, a frequency of appearance of the embedded marker based on a sparse sampling algorithm.

18. The method of claim 17, wherein determining the at least one pupil location comprises:
determining the at least one pupil location based on sampling the embedded marker.

19. The method of claim 16, wherein detecting the embedded marker comprises:
detecting the embedded marker from a plurality of directions corresponding to a position of each of the plurality of eye tracking sensors disposed on the HMD.

20. The method of claim 16, wherein detecting the embedded marker comprises:
detecting the embedded marker reflected from at least one of a cornea and a sclera of an eye.
